(19) United States
(12) Patent Application Publication
(10) Pub. No.: US 2006/0036948 A1
(43) Pub. Date: Feb. 16, 2006

(54) Image selection device and image selecting method

(76) Inventor: Kenji Matsuzaka, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/000,336

(22) Filed: Nov. 29, 2004

(30) Foreign Application Priority Data
Nov. 27, 2003 (JP) 2003-396571

(51) Int. Cl. G11B 27/00

(52) U.S. Cl. 715/723

(57) ABSTRACT

The image selection processing device of the present invention is an image selection processing device for selecting as still images part of a moving image based on specified setting conditions, comprising an image extraction unit for extracting a plurality of images from the image group that forms the moving image, a movement detection unit for detecting the parts with movement within the images for each of the extracted images, a sequence setting unit for evaluating the parts with movement within the detected images based on the specified setting conditions and doing sequence allocation for each of the extracted images, and an output unit for outputting the still images based on the sequence allocation. With this image selection processing device, it is possible to efficiently select desired images from a plurality of images.

### CLAIM OF PRIORITY

The present application claims priority from Japanese application P2003-396571 filed on Nov. 27, 2003, the content of which is hereby incorporated by reference into this application.

### BACKGROUND OF THE INVENTION

1. Field of the Invention

The present invention relates to an image selection process device for selecting a specified still image from a plurality of images included in a moving image, an image selection method, and a computer program and recording medium.

2. Description of the Related Art

Conventionally, to cut a still image from a plurality of images contained in a moving image, various methods have been used. For example, when extracting a frame image (one image comprised by a moving image) that symbolizes the contents of that moving image from a moving image captured by a digital video camera, by the user manually confirming the contents by repeating play, fast forward, and the like for the moving image, one frame image was determined (e.g. JP-A-2000-299829).

It takes time to reach the target frame image using this kind of manual operation by the user, so a method of uniformly extracting a frame image at each five second interval, for example, and searching for the target item from the extracted plurality of frame images, or a method of equally separating the moving image playback time into the number of frame images to cut out, and then cutting out the concerned frame image, and the like were performed.

However, with this kind of method of simply uniformly cutting out frame images, there was the problem that an image that would symbolize the contents of the moving image may not be included in the cut out frame images. For example, in a case such as when, by chance, the frame images of the number of frames cut out at equal time intervals were scene change frame images, then meaningless frame images would have been extracted.

### SUMMERY

The purpose of the present invention is to solve a part of the above problem, and to execute image processing for efficiently selecting a desired image from a plurality of images.

The first aspect of the image selection process device of the present invention takes into consideration the issues noted above and uses the following method. Specifically, the image selection process device of the present invention is an image selection process device for selecting as a still image part of a moving image constituted as an image group comprising a plurality of images, the key points being that it comprises an image extraction unit for extracting a plurality of images from an image group for constituting the moving image, a movement detection unit for detecting parts for which there is movement within the image for each of the extracted images, a sequence setting unit for allocating a sequence to each of the extracted images, and an output unit for outputting the still images based on the sequence allocation.

Also, the first aspect of the image selection method of the present invention is an image selection method for selecting as a still image part of a moving image formed as a group of images comprising a plurality of images, the key points being that a plurality of images are extracted from the image group that forms the moving image, detects parts for which there is movement within the image for each of the extracted images, evaluating the parts for which there is movement within the detected images, performs sequence allocation for each of the extracted images, and outputs the still images based on the sequence allocation.

According to the first image selection processing device and the image selection method, a plurality of images that are candidates for the finally output still images are extracted, and by evaluating the movement parts within the extracted images, a sequence is allocated to the candidate images, and an image that matches the conditions is selected. In other words, by evaluating the still images contained in a moving image, it is possible to automatically select a desired image. Therefore, it is possible to efficiently select the desired images from within the moving image. From the start, it is also possible to comprise an evaluation standard setting unit for setting evaluation standard which are the conditions for evaluation the part for which there is movement within the detected image, and to perform evaluation of the part for which there is movement based on the set evaluation standard. In this case, the image sequence is set according to the evaluation standard, so selection of desired images becomes even easier.

The image extraction art of the image selection processing device having the constitution noted above may also be a means for acquiring information relating to the switching of scenes for the moving image and extracting a plurality of images for each of the scenes, and for performing output of the still images based on the sequence allocation for each scene in the moving image.

According to this image processing device, the image extraction unit acquires the brightness information of each image, or information relating to the switching of scenes such as the movement of a camera that captured a moving image or the like, for example, determines the scope of each scene, and extracts a plurality of images that are candidates for each scene. Then, the output unit outputs still images based on the sequence allocation for the plurality of extracted images. Therefore, it is possible to select a still image that matches the desired setting conditions for each scene. This is particularly effective for generating a capture for displaying the contents of the moving image, or the like.

The movement detection unit of the image selection processing device having the constitution noted above may comprise a subject image selection unit for selecting a subject image having the desired correlation with each of the extracted images, and a displacement volume detection unit for detecting the position displacement volume of the image capture subject between the images in relation to the extracted images and the selected subject image, and may be means by which displacement volume correction is performed between the images, and based on the partial positional displacement between the images after the correction, detection of the part for which there is movement within the extracted image is performed.

According to this image selection processing device, the movement detection unit detects the part for which there is movement as a characteristic of each of the extracted images based on the displacement volume of the image capture subjects between the images. For example, the part for which movement is detected may be evaluated as indices of position, size and the like within an image, and a sequence may be allocated to each of the extracted images.

The output unit of the image selection processing device having the constitution noted above may comprise a related image evaluation unit for performing evaluation based on the setting conditions for the related images that are close in terms of time series to the still images that are candidates for output in advance of output of the still images based on the sequence allocation, and may use a means for which when the evaluated related image is a higher sequence than the output candidate still image, instead of the output candidate still image, or together with the output candidate still image, the related image is output.

According to this image selection processing device, before the final still image selection, the images that are close in terms of time series to the still image are extracted as related images, and when the evaluation of the related image is higher compared to the still image an attempt is being made to select, that related image is selected. Therefore, it is possible to do a close inspection near the still images and to select an image that matches the set conditions.

The movement detection unit of the image selection processing device having the aforementioned constitution may also separate the extracted images into block units of a specified size, and may use means for detecting the presence or absence of movement in block units. According to this image selection processing device, movement is detected in block units, and evaluation of the overall image and sequence allocation are performed. Therefore, it is possible to shorten the processing time for the overall image evaluation.

The sequence setting unit of the image selection processing device having the constitution noted above may comprise a coefficient storage unit for storing a plurality of evaluation coefficients for giving weighting of the evaluation for each of the separated blocks as the matrix corresponding to each block, a matrix selection unit for selecting as an evaluation coefficient matrix one matrix from the plurality of matrices based on the evaluation standard, a calculation unit for reading the evaluation coefficient corresponding to the detected block for which there is movement from the one evaluation coefficient matrix and for calculating the evaluation value of the overall image using the read evaluation coefficient, and a sequence allocation unit for allocating a sequence based on the calculated evaluation value.

According to this image selection processing device, the overall image evaluation value is calculated from each block for which movement is detected and the value of the evaluation coefficient matrix corresponding to these. For example, it is possible to arrange such that when an evaluation coefficient matrix for which a high value is set for the block near the center of the image is specified, a flag 1 is raised for the block for which there is movement, and have the overall image evaluation value be the sum of the values obtained by multiplying the value of the corresponding evaluation coefficient matrix. When constituted in this way, images with a high evaluation value are images for which the blocks which have movement are positioned near the center of the image. Therefore, this is particularly effective when selecting images for which the blocks with movement are in the desired position.

For the sequence setting unit of the image selection device having the constitution noted above, it is also possible to have the means allocate the sequence based on the state of the blocks with movement within each of the images when a plurality of images are extracted for which the evaluation value difference is within a specified range. According to this image selection processing device, when the evaluation value for two images are equal, for example, it is possible to perform sequence allocation using as the standard the state of the number, size, or the like of each of the blocks for which there is movement.

For the sequence setting unit of the image selection device having the constitution noted above, it is also possible to have this be means for performing sequence allocation of the extracted images by determining the skin color area of the colorimetric system for the blocks for which there is movement among the detected images, so that images which have a high count of movement blocks indicating the flesh color area have a high sequence priority. According to this image selection processing device, the sequence allocation is performed by determining particularly the flesh color areas within blocks with movement, and images with a high count of movement blocks determined to be flesh color have a high sequence priority. There is a high possibility of a “person's face” being captured in the high sequence priority images, and for example, this is particularly effective in cases of selecting images for which a “person's face” as the subject matter falls within the desired range.

For the image selection processing device having the constitution noted above, the plurality of evaluation coefficient matrices may be matrices for which a coefficient is set with weighting for each block corresponding to the desired composition. Also, the sequence setting unit comprises means for determining whether or not the blocks having movement among the detected images fall within the specified composition, and the output unit may be a unit for outputting the still images that fall within the specified composition.

According to this image selection processing device, a specified composition is assumed as the evaluation coefficient matrix, and to be able to obtain a high evaluation value, weighting is given to the blocks with movement that fall within that composition. By performing sequence allocation using the evaluation coefficient matrices for which this weighting is given, it is possible to automatically select an image that matches the composition from among a plurality of images.

For the sequence setting unit of the image selection processing device having the constitution noted above, it is also possible to use a means whereby using the evaluation value for which the value of the number of blocks with movement is excluded, the ratio of the subject matter held within the specified composition is calculated, and the sequence allocation of the extracted images is performed based on this ratio. According to this image selection processing device, when doing calculation, this becomes an index representing to what level the blocks with movement fall within the desired scope. By using this index, it is possible to easily perform sequence allocation.

For the image selection processing device having the constitution noted above, it is also possible to have the sequence setting unit have the sequence go higher in order from images with a low total area of the parts with movement detected for each of the extracted images when the setting condition is a condition to select items with a small portion with movement within an image. According to this image selection processing device, with images for which there is a large portion with movement as the low end, it is possible to intentionally select images with a low portion with movement. This is effective when there is a desire to select “background images” or the like, for example.

The present invention may also be realized as a computer program product or as a recording medium on which is recorded a computer program.

### BRIEF DESCRIPTION OF THE DRAWINGS

FIG. 1 is an explanatory drawing showing the image selection processing system as a first embodiment of the present invention.

FIG. 2 is an explanatory drawing showing an example of the operating screen of the image selection process of the first embodiment.

FIG. 3 is an explanatory drawing of the image selection process.

FIG. 4 is a flow chart of the image selection process of the first embodiment.

FIG. 5 is a flow chart of the “background” frame image detection process.

FIG. 6 is an explanatory drawing showing an example of the characteristic volume of each candidate frame image of the “background” frame image detection process.

FIG. 7 is a flow chart of the “movement” frame image detection process.

FIG. 8 is a flow chart of the “movement” score calculation process.

FIG. 9 is an explanatory drawing showing an example of each candidate frame image of the “movement” score calculation process.

FIG. 10 is an explanatory drawing showing an example of the candidate frame images selected according to the “movement” score calculation process.

FIG. 11 is an explanatory drawing showing an example of the score coefficient table used with the first embodiment.

FIG. 12 is an explanatory drawing showing an example of the score values of the first embodiment.

FIG. 13 is an explanatory drawing showing an example of the score coefficient table.

FIG. 14 is a flow chart of the “movement” score calculation process of the second embodiment.

FIG. 15 is an explanatory drawing showing an example of the score coefficient table used with the second embodiment.

FIG. 16 is an explanatory drawing showing an example of the score value of the second embodiment.

### DESCRIPTION OF THE PREFERRED EMBODIMENTS

Following, aspects of implementing the present invention are described based on embodiments in the following order.
A. First Embodiment:
   A1. Constitution of the Image Selection Processing Device:
   A2. Image Selection Process:
   A3. Background Frame Image Detection Process:
   A4. Movement Frame Image Detection Process:
   A5. Score Coefficient Table:
B. Second Embodiment:
   B1. Image Search Process Matching the Composition:
C. Variation Examples:

### A. First Embodiment

A1. Constitution of the Image Selection Processing Device

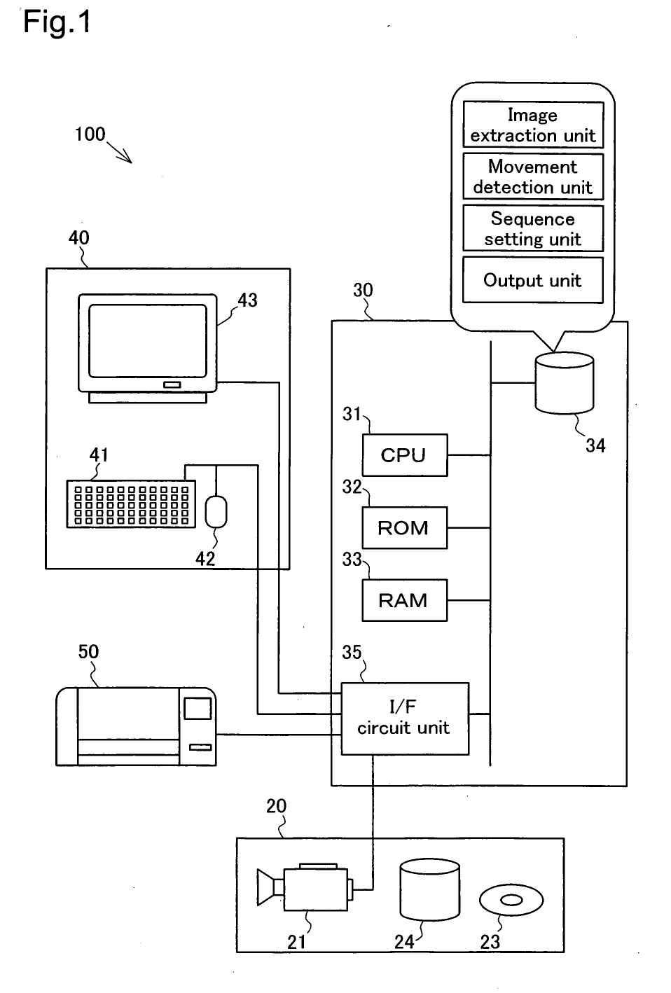

FIG. 1 is an explanatory drawing showing the image selection processing system 100 as a first embodiment of the present invention. As shown in the figure, this image selection processing system 100 comprises an image database 10 for supplying moving image data, a personal computer 30 as the image selection processing device for executing the image selection process on a plurality of images input from the image database 20, a user interface 40 for the user to give instructions to execute the image selection process, and a color printer 50 for outputting the image or the like selected by the image selection processor to paper.

The image database 20 comprises an apparatus for handling images such as a digital video camera 21, a DVD 23, a hard disk 24, or the like, and supplies image data to the personal computer 30. Note that the image data held in the image database 20 of this embodiment is moving image data acquired by the digital video camera 21. This moving image data consists of a gathering of image data that is consecutive in terms of time, and each image data is called a frame image. Hereafter, the “image selection process” of this embodiment will be described as a process for selecting as “still images” frame images that satisfy specified conditions from a plurality of frame images.

The personal computer 30 comprises a CPU 31 for executing the image selection process, a ROM 32, a RAM 33, a hard disk 34 for installing the image selection process software, the image database 20, the user interface 40, and an interface circuit unit 35 for interacting with external equipment such as the color printer 50, and the like. The image selection process of the software installed in the hard disk 34 comprises a moving image data read function, a specified number of frame images extraction function, a detection function for the characteristic volume of the extracted frame images, a sequence allocation function for each of the frame images based on the characteristic volume, and a function for outputting the frame images in upper sequence. The personal computer 30 on which this software is installed comprises the functions of an “image extraction unit,” “movement detection unit,” “sequence setting unit,” and “output unit” as an image selection processing device. Note that the flow of this image selection process will be described in detail later.

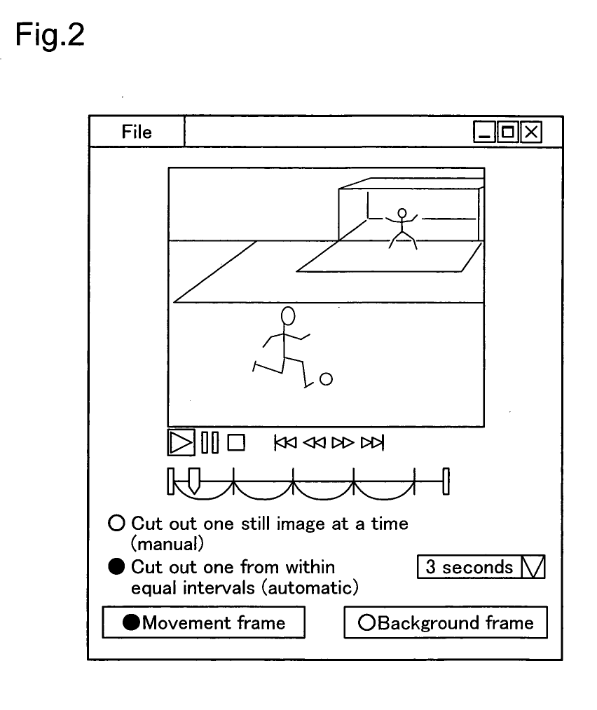

The user interface 40 comprises items such as a keyboard 41 and a mouse 42 for the user to perform image selection processing execution operations, and a display 43 for displaying moving images and the like. Displayed in this display 43 is an operating screen of the image selection process shown in FIG. 2, for example. As shown in the figure, this operating screen comprises a part for performing playback of moving images that are subject of sampling specified frame images and the like, and a part for setting the conditions of the frame images desired by the user. The user executes the image selection process by performing the setting operation using the keyboard 41 and the mouse 42.

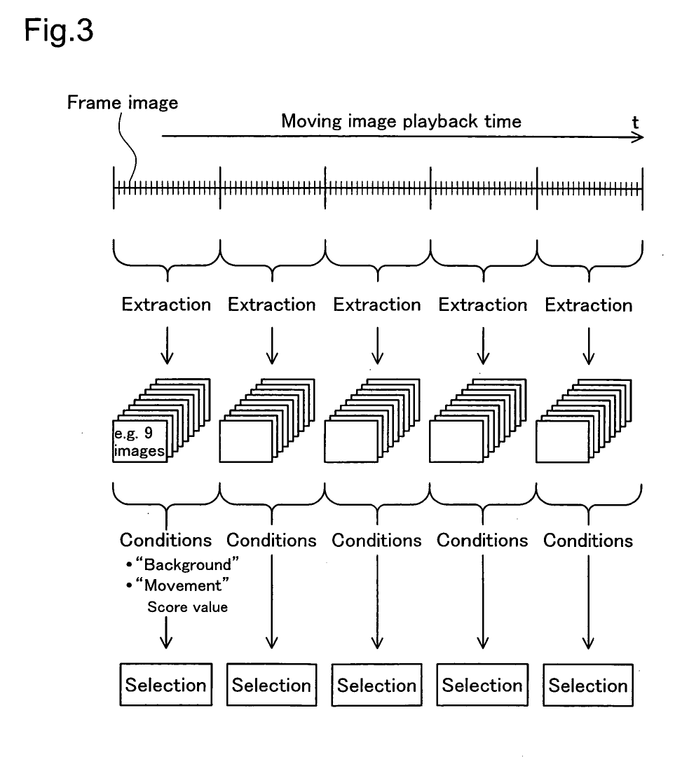

FIG. 3 shows a schematic drawing of one series of this image selection process. As shown in the figure, this image selection process is a process whereby the plurality of frame images is extracted from a specified time interval of the moving image, a sequence is allocated to the plurality of extracted frame images based on the specified conditions, and the high order frame images are selected. Following, the details of this image selection process are described.

A2. Image Selection Process:

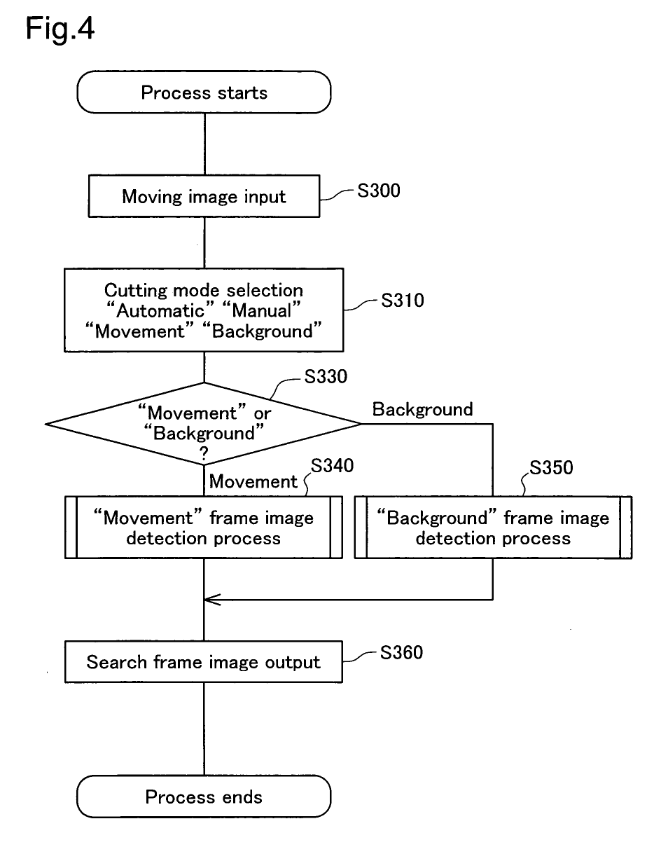

FIG. 4 is a flow chart of the image selection process of the first embodiment for selecting one frame image that patches specified conditions from the plurality of frame images that constitute the moving image. With the image selection process system 100 having the hardware configuration described above, the image selection process installed in the personal computer 30 starts by the user operating the keyboard 41.

When the image selection process starts, the personal computer 30 inputs the moving image data which is a collection of the frame image data from the image database 20 (step S300) and this is displayed on the display 43. With this embodiment, the moving image data is input directly from the digital video camera 21, but it is also possible, for example, to display a list of the files of the hard disk 24 and for the user to select one from the list when inputting from the hard disk 24 which houses the plurality of moving image data.

Next, the user performs the “cutting mode selection” operation for setting the conditions of the frame images for which selection is desired (step S310). The “cutting mode” includes a condition setting of the extraction (cutting) scope for the frame images and a condition setting of the subject matter included in the frame image. As shown in the operating screen of FIG. 2, the choices of the scope condition settings include a “manual” mode for the user to select one frame image that matches the setting conditions from among that scope with the moving image segmented at specified time intervals, and an “automatic mode” for selecting one frame image that matches the setting conditions for each time interval with the user specifying a specified time. Meanwhile, the choices of the subject matter conditions settings include a “movement” frame mode for selecting items with movement as the subject matter within the frame image, and a “background” frame mode for selecting items with little movement such as “backgrounds” and the like. The user performs mode setting by selecting each type of mode on the operating screen and clicking using the mouse 42.

The personal computer 30 makes a determination of whether the subject matter condition set by the user is the “movement” frame image or the “background” frame image (step S330).

At step S330, when the personal computer 30 determines that the user specified the “movement” frame image, it executes the “movement” frame image detection process for detecting “movement” frame images from the setting condition moving image scope (step S340). With the “movement” frame image detection process, a specified number of frame images is extracted from within the scope specified using the “manual” mode or from within the time interval specified using the “automatic mode,” and sequence allocation is performed for each of the extracted frame images by the specified setting conditions.

Meanwhile, at step S330, when it is determined that the user specified the “background” frame image, the personal computer 30 executes the “background” frame image detection process for detecting “background” frame images from the moving image scope of the setting conditions (step S350). With the “background” frame image detection process, a specified number of frame images is extracted from within the scope specified by the “manual” mode or from within the time interval specified using the “automatic” mode, and sequence allocation is performed for each of the extracted frame images according to the specified setting conditions.

Both of these detection processes have a common point in that they are processes whereby a specified number of frame images area extracted as candidates from within the scope set by selecting the “manual” or “automatic” mode (these frame images extracted as candidates are called candidate frame images), and a sequence is allocated to those frame images, but they are different in terms of the determination standard for doing sequence allocation and the like. Both of these detection processes will be described in detail later.

Through each detection process, the personal computer 30 selects the frame image that is the first of the sequence allocated to the candidate frame images, that frame image is displayed in the display 43 (step S360), and this process ends. Note that when the mode set at step S310 is the “automatic” mode, the personal computer 30 selects one frame image for each of the set time intervals, and does a thumbnail display on the display 43 of the plurality of frame images across the entire playback time of the moving image.

A3. Background Frame Image Detection Process:

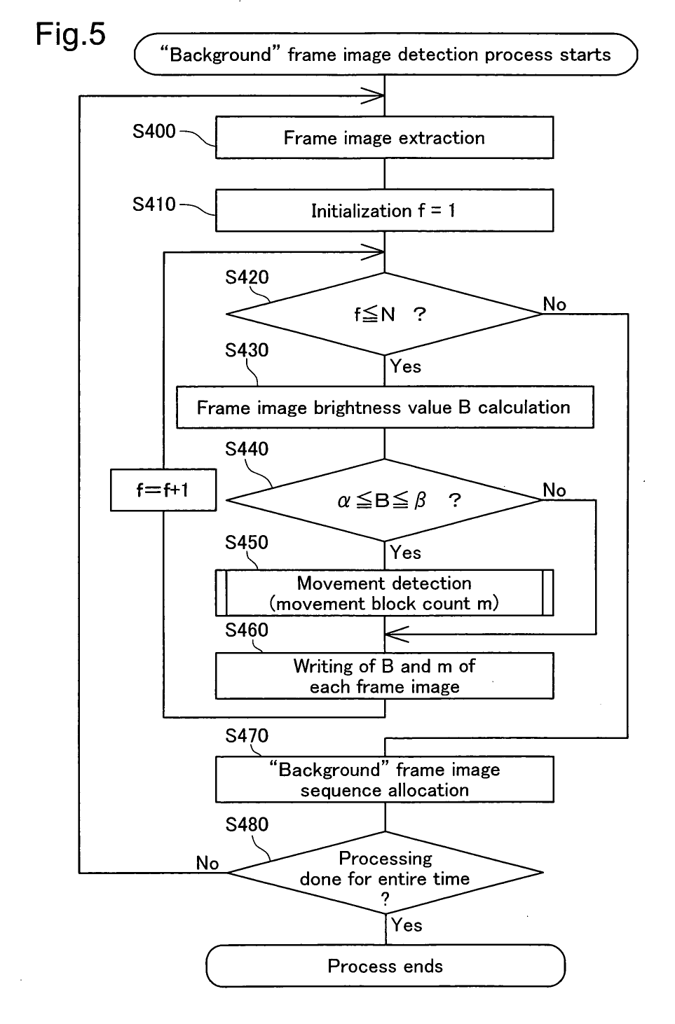

FIG. 5 is a flow chart of the “background” frame image detection process that is a sub-routine of the image selection process of the first embodiment. At step S310 shown in FIG. 4, when the user selects the “background” frame image, this sub-routine starts. When in the “manual” mode, the personal computer 30 extracts a specified number N of candidate frame images from the playback time intervals (e.g. between 15 seconds to 20 seconds of the playback time) set by the user on the operating screen shown in FIG. 2. Meanwhile, when in the “automatic” mode, a specified number N of candidate frame images is extracted from the scope of each time interval input by the user on the operating screen (e.g. every 3 seconds of the playback time) (step S400). Following, with this embodiment, a case will be described of the “automatic” mode being selected, and nine candidate frame images (N=9) from the 3 second scope being extracted. Note that the specified number N may also be changed according to the time interval of the “manual” mode, or may be set freely by the user.

The personal computer 30 performs numbering in time sequence on the nine candidate frame images f extracted from the three second scope, and sets the initial conditions (f=1) for executing the following step in time sequence (step S410).

Next, the personal computer 30 selects one candidate frame image f from the nine candidate frame images, and confirms that the number of that candidate frame image f is the same or less than the specified number (N=9) (step S420). In other words, at this step S420, a determination is made of whether the process of calculating the following characteristic volume has been implemented on all the candidate frame images.

At step S420, when it is determined that the characteristic volume has not been calculated for the one candidate frame image, the personal computer 30 performs the process of calculating the image brightness value B for that selected candidate frame image (with the initial process, the candidate frame image f=1 that is the first in the time sequence)(step S430). Here, the average value of the brightness value of each pixel that constitutes the one candidate frame image f is calculated, and this is used as the brightness value B.

The personal computer 30 makes a determination of whether or not the calculated brightness value B is within the specified scope (step S440). At step S440, when the brightness value B of the candidate frame image f does not fall within the specified scope (α≦B≦β), without the “movement detection” process that is the next step being performed, the brightness value B for that candidate frame image f is written to memory such as the RAM 33 or the hard disk 34 or the like (step S460), and processing from step S420 is performed for the next candidate frame image (f=f+1). At step S440, it is possible to exclude undesirable images such as completely dark images that are images when the brightness value B is smaller than α, or too bright images that are images when the brightness value B is greater than β.

Meanwhile, at step S440, when the brightness value B of the candidate frame image f does fall within the specified scope, the personal computer 30 performs “movement detection” processing on that candidate frame image f (step S450). With the “movement detection” process, the frame images that are successive in terms of time sequence (these are called subject frame images) are extracted for the candidate frame images f, and by comparing the candidate frame images f and the subject frame images, the parts with movement within the candidate frame images f are detected.

When moving to the “movement detection” process of step S450, the personal computer 30 extracts as the subject frame image the frame image that is at the back of the time sequence in relation to the candidate frame images f, and using a known gradient method, the translational displacement volume (u, v) between both frame images is calculated. Based on this calculated displacement volume (u, v), a correction is made to overlap the subject frame image on the candidate frame image f. This correction corrects positional displacement between two frame images due to hand shaking blur or to panning and tilting or the like. With this embodiment, both frame images after correction are divided respectively into 16×12 blocks, and the displacement volume (ub, vb) is similarly calculated between blocks corresponding to both frame images. The displacement volume between the blocks calculated here is the volume for which the positional displacement between both frame images is removed, representing the “movement” within the image. In other words, the personal computer 30 determines items for which the displacement volume between blocks that exceed a certain threshold value to be “movement blocks.” In this way, a determination is made for all blocks as to whether they are “movement blocks” or not, and the block number m of the “movement blocks” is calculated.

The personal computer 30 writes the calculated brightness value B and the movement block number m for the one candidate frame image f to the memory (step S460), and the process from step S420 is repeated for the next candidate frame images in sequence.

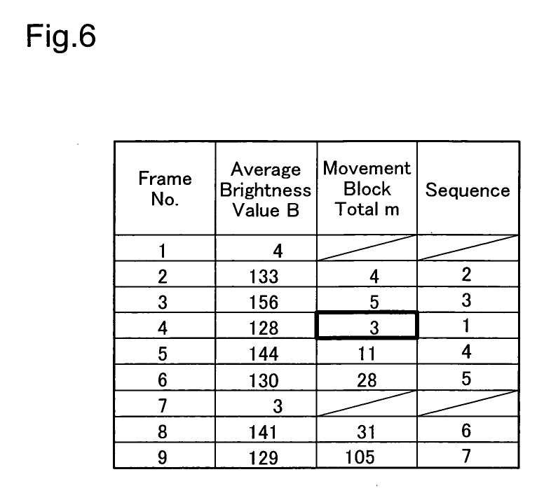

When at step S420 it is determined that the characteristic volume of the brightness value B and the movement block count m has been written to the memory for all the candidate frame images, the personal computer 30 performs sequence allocation for each of the candidate frame images (step S470). FIG. 6 shows an example of the characteristic volume of each of the candidate frame images calculated in this way. With this sub-routine, because the subject matter is “background,” the sequence of each of the candidate frame images is allocated by the movement block count m as shown in FIG. 6. In other words, with the “background” frame image detection, items that have the specified brightness value B and have a low movement block count m are used as the high sequence priority.

Next, the personal computer 30 makes a determination of whether the sequence allocation process was executed for all times (step S480). In specific terms, when the setting condition is the “manual” mode, or over the entire playback time that it is the “automatic” mode, when the sequence allocation process is executed, the process is executed for the entire scope specified by the user, so this sub-routine ends, and there is a return to the flow chart shown in FIG. 4. Meanwhile, when the sequence allocation process has not ended across the entire playback time with the “automatic” mode, for example, when processing has been executed for the 0 to 3 second period with the playback time, but has not been implemented for the next 3 to 6 seconds, the process returns to step S400, the frame images are extracted from the 3 to 6 second scope, and the process described above is repeated.

After the sub-routine ends in this way, as described previously, the personal computer 30 returns to step S360 of the flow chart shown in FIG. 4, the candidate frame image which is first in the sequence is displayed on the display 43 as the still image that best matches the conditions, and all the image selection processing ends.

A4. Movement Frame Image Detection Process:

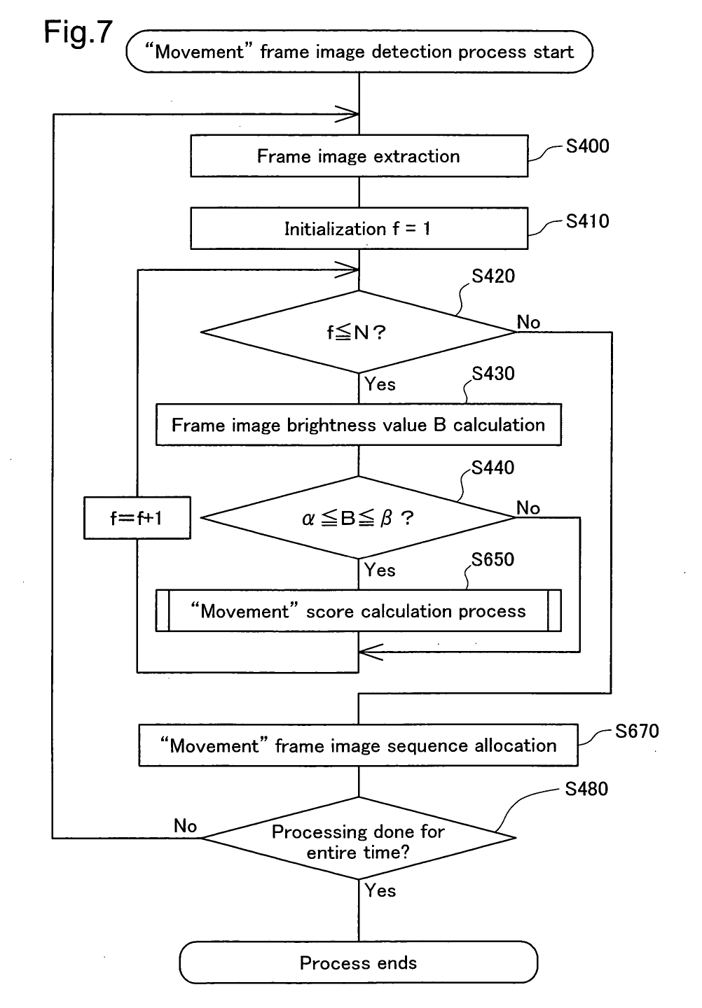

FIG. 7 is a flow chart of the “movement” frame image detection process that is a sub-routine of the image selection process of the first embodiment. At step S310 shown in FIG. 4, when the user selects the “movement” frame image, this sub-routine starts. This sub-routine is only different from the “background” frame image detection process in terms of the movement detection (steps S450 and S460) and the sequence allocation (step S470) process. Therefore, in relation to other processes, the same numbers as the step numbers shown in FIG. 5 are used for a brief description.

The personal computer 30 extracts a specified number N of the candidate frame images from the scope corresponding to the respective “manual” and “automatic” modes (step S400). With this embodiment, the same as the “background” frame image detection process shown in FIG. 5, nine candidate frame images are extracted under the conditions of the “automatic” mode and three second intervals.

The personal computer 30 sets the initial conditions (step S410), and determines whether or not the number of the candidate frame images f are the specified count or less (step S420). At step S420, when it is determined that the brightness value B which is the characteristic volume has not been calculated for the one candidate frame image, the process of calculating the brightness value B of the image for that candidate frame image is performed (step S430).

Next, a determination is made of whether or not the calculated brightness value B is within the specified scope (step S440). At step S440, when the brightness value B does not fall within the specified scope (α≦B≦β), the process from step S420 is repeated for the next candidate frame image (f=f+1). Meanwhile, at step S440, when the brightness value B of the candidate frame image f falls within the specified scope, the personal computer 30 performs the “movement” score calculation process in relation to that candidate frame image f (step S650). At step S440, the same as the background frame image detection process, by selecting the images for which the brightness value B falls within the specified scope, it is possible to exclude images that are too dark and images that are too light.

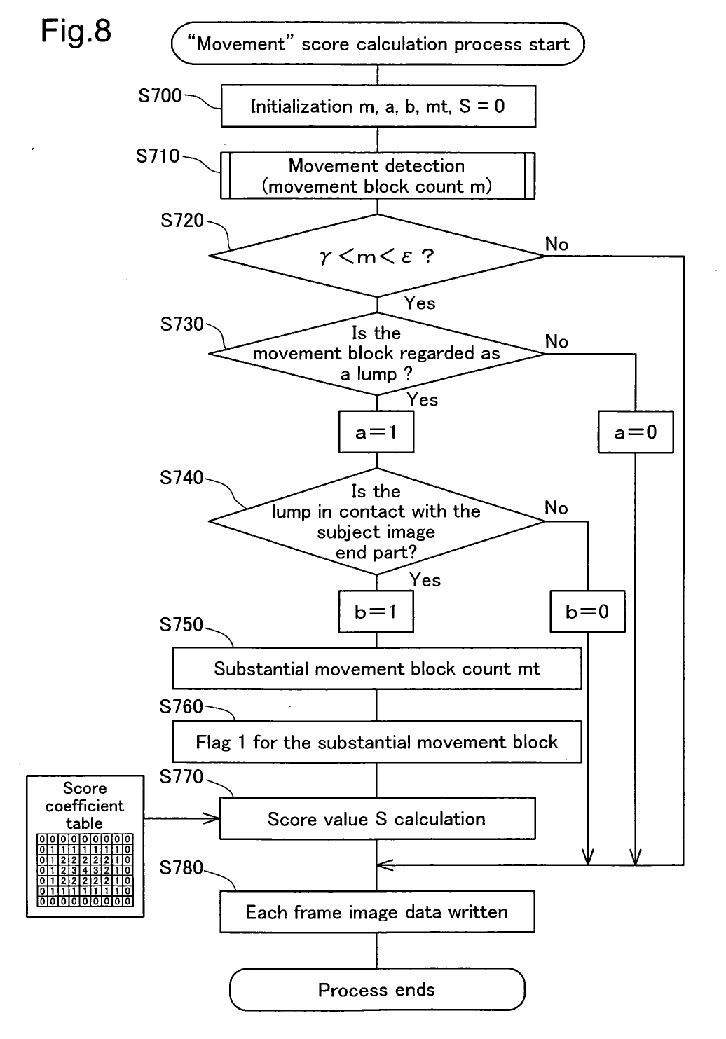

FIG. 8 is a flow chart of the “movement” score calculation process that is a sub-routine of the “movement” frame image detection process. When this sub-routine is moved to, the personal computer 30 first performs initialization of the coefficient used for the following score calculation (step S700). Next, the same as with the “background” frame image detection process, the subject frame images that are consecutive in time series are extracted for the candidate frame images f, and the movement detection process for detecting movement blocks within the candidate frame images f is executed (step S710).

The personal computer 30 determines whether or not the movement block count m obtained at step S710 falls within the specified scope (step S720). With this embodiment, the lower limit value γ for indicating the specified scope is set to 1/50 of the total area of the frame image, and the upper limit value εis set to half the total area of the frame image. By selecting the images that satisfy the conditions within this specified range, the frame images that have an extremely low movement block count m (area for which movement was detected) and have almost no movement, and the frame images that have an extremely high movement block count m and have movement in almost the entire area of the image are eliminated as subjects of the final selection.

When it is determined at step S720 that the movement block count m of the one candidate frame image f is not in the specified scope, the personal computer 30 writes the movement block count m to the memory without calculating the score (step S780), this sub-routine ends, and the process returns to the “movement” frame image detection process of FIG. 7.

Meanwhile, when it is determined that the movement block count m of the one candidate frame image f is within the specified scope, the personal computer 30 makes a determination of whether or not the movement blocks are regarded as consecutive blocks (step S730). To determine whether or not they are consecutive blocks, a labeling process for adding group attributes based on the color information of each pixel is used. This labeling process is a known process that does binarization of images using a threshold process and performs label allocation by checking the overlapping of subject matter for each scan line. By using this process, the personal computer 30 is able to recognize consecutive movement block groups as a lump of blocks within each individual movement block.

When it is determined at step S730 that the movement blocks of the one candidate frame image f are not consecutive (in other words, there is no correlation between the blocks, and they cannot be regarded as a lump of blocks), the personal computer 30 sets a flag a=0 indicating that these are not consecutive blocks, the movement block count m and the flag a are written to the memory (step S780), this sub-routine ends, and the process returns to the “movement” frame image detection process of FIG. 7.

Meanwhile, when it is determined that the movement blocks of the one candidate frame image f are consecutive (a lump of blocks), the personal computer 30 sets a flag a=1 indicating that these are consecutive blocks, and moves to the next step. Then, the personal computer 30 determines whether or not the consecutive blocks (lump) of the one candidate frame image f are in contact with the image end part, and when there are blocks (lump) that are in contact with the end part, a confirmation is done of whether or not there are movement blocks within the candidate frame image for which those blocks are excluded (step S740).

When at step S740 it is determined that the consecutive blocks (lump) of the one candidate frame image f are in contact with the image end part, and as a result of removing the consecutive blocks (lump), there are no other movement blocks, the personal computer 30 sets a flag b=0 indicating that there are substantially no movement blocks, writes the movement block count m and the flag a and flag b to the memory (step S780), this routine ends, and the process returns to the “movement” frame image detection process of FIG. 7.

Meanwhile, when it is determined that the consecutive blocks (lump) of the one candidate frame image f are not in contact with the image end part, or when as a result of removing the consecutive blocks (lump) that are in contact with the end part, it is determined that other movement blocks exist, the flag b=1 indicating that movement blocks substantially exist is set, and a calculation is done (step S750) of the number of movement blocks that exist within the candidate frame image f for which the consecutive blocks (lump) are in contact with the end part have been removed (hereafter, called substantial movement block count mt).

The personal computer 30 raises the flag 1 for the block that is the calculated substantial movement block, raises the flag 0 for other blocks (step S760), and multiplies the coefficient value of the score coefficient table corresponding to each block by the flag value (0 or 1) of each block. This calculation is performed for all blocks that form an image, the sum of the product values is taken, and this is used as the score value S (step S770).

After calculation of the score value S, the personal computer 30 writes to the memory the movement block count m, the flag a, the flag b, the substantial block count mt, and the score value S for the one candidate frame image f (step S780), this sub-routine ends, and the process returns to the “movement” frame image detection process in FIG. 7.

Returning to the “movement” frame image detection process in FIG. 7, the personal computer 40 returns to step S420 for determining whether or not to perform the calculation of the score value S for the next candidate frame image in the time series (f=f+1). At step S420, when it is determined that there are still unprocessed candidate frame images, the score value S calculation process described above is repeated.

Meanwhile, when it is determined at step S420 that the processing has ended for all the candidate frame images, the personal computer 30 performs sequence allocation of the “movement” frame images (step S670) based on the score value S of each candidate frame image. With this embodiment, the upper level is in sequence from the candidate frame images for which the score value S is high.

After the sequence allocation is performed (in other words, the candidate frame image set as number one in the sequence), the personal computer 30 determines (step S480) whether or not one sequence of “movement” frame image detection process has been executed for the scope of all times specified by the user. When the process has not been executed across the entire time, the process returns to step S400, the processing is repeated, and when it is determined that the process has been completed within the scope specified by the user, the “movement” frame image detection process ends. After this process ends, as described previously, the personal computer 30 returns to step S360 of the flow chart shown in FIG. 4, the candidate frame image that is number one in the sequence is displayed on the display 43 as the still image that most closely matches the conditions, and all the image selection processing ends.

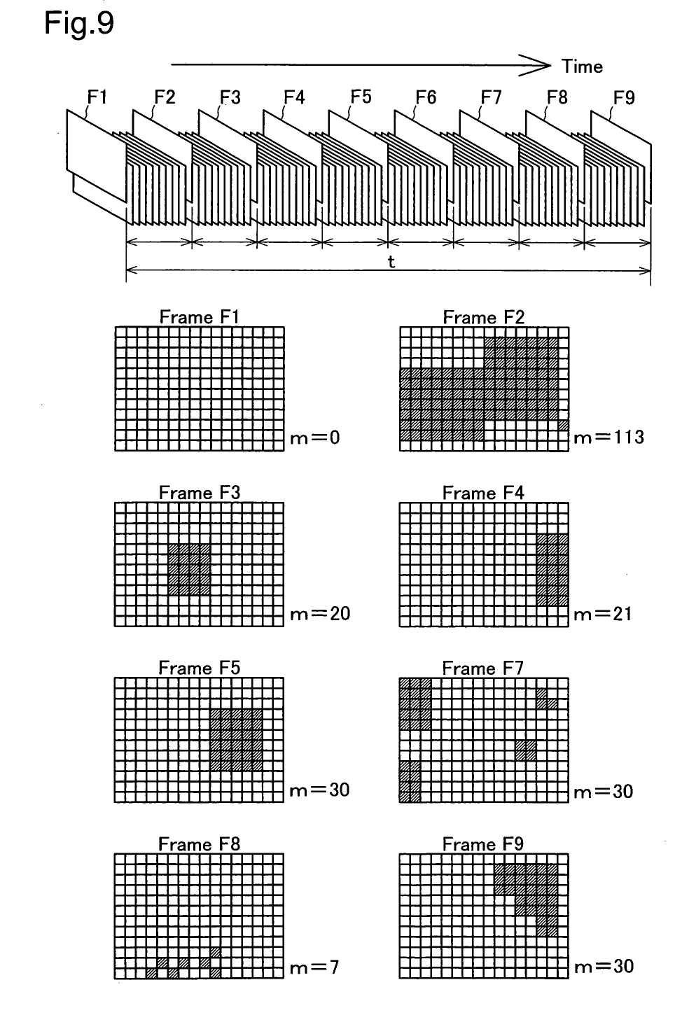

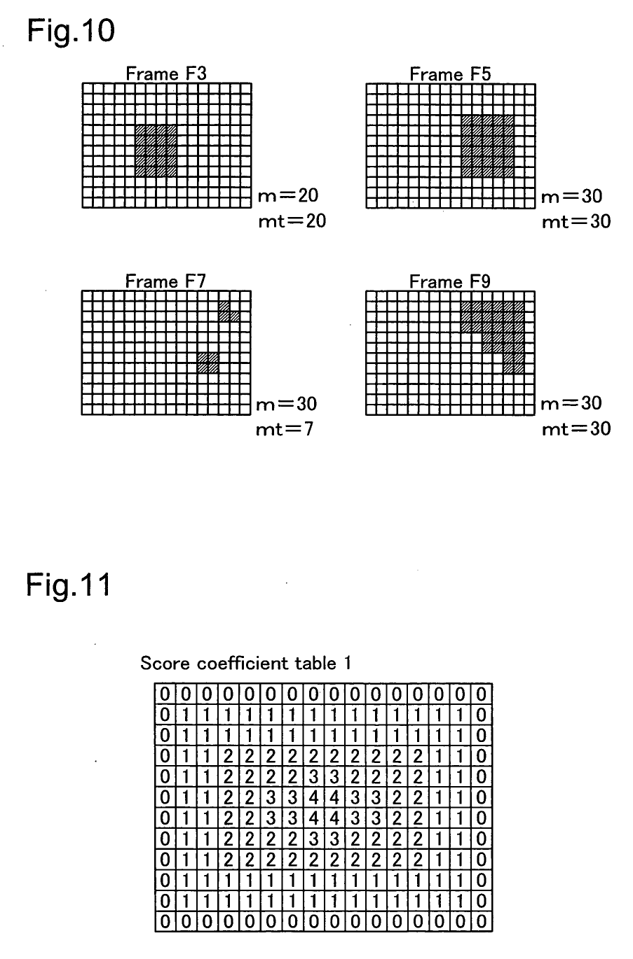

A specific description will be given of this one series of “movement” score calculation processing using from FIG. 9 to FIG. 11. FIG. 9 is an explanatory drawing showing an example of the candidate frame image. FIG. 10 is an explanatory drawing showing an example of a candidate frame image narrowed down according to the “movement” score calculation process. FIG. 11 is an explanatory drawing showing an example of the score coefficient table and the score values.

As shown in FIG. 9, with this embodiment, nine candidate frame images (F1 to F9) are extracted from a scope of three seconds of playback time of the moving image, and the condition of the brightness value B is determined for each of the candidate frame images (following, called simply frames F1 to F9). Each of the frames shown in FIG. 9 satisfies the brightness value B, and the status after the movement block detection is indicated. The cross hatching of the blocks of each frame (F1 to F5, F7 to F9) in the drawing indicates that these are movement blocks. For example, for the frame F3, twenty blocks are movement blocks, and m=20 is displayed. Note that for the frame F6, the brightness value B does not fall within the specified scope, and this as a frame image for which the “movement detection” is not executed.

When a determination is made of whether or not the movement block count m is in the specified scope (step S720) for the eight frames (F1 to F5, F7 to F9) shown in FIG. 9, for the frame F1, the movement block count m is smaller than a, and for the frame F2, the movement block m is greater than b, so neither frame satisfies step S720, the movement block m of the frames F1 and F2 are written to the memory (step S780), and this sub-routine ends. Specifically, the score calculation is not performed for the frames F1 and F2. Meanwhile, the frames F3 to F5 and F7 to F9 satisfy step S720, and the process moves to the next step.

When a determination of the correlation of the movement blocks (step S730) is executed for the frames F3 to F5 and F7 to F9 which satisfied the conditions of the movement block count is executed, for the frame F8, the movement blocks are not consecutive, and this condition is not satisfied. In this case, the flag a=0 indicating that these are not consecutive blocks is set, the movement block count m and the flag a of the frame F8 are written to the memory (step S780), and this sub-routine ends. Meanwhile, the frames F3, F4, F5, F7, and F9 satisfy step S730, the flag a=1 indicating that these are consecutive blocks is set, and the process moves to the next step.

For the frames F3, F4, F5, F7, and F9 that satisfied the consecutiveness condition, when a determination of whether or not this is in contact with the image end part (step S740) is executed, for the frame F4, the consecutive blocks are in contact with the end part, so when this is removed, there are no movement blocks within the frame. Thus, the flag b=0 indicating that substantially there are no movement blocks is set, the movement block count m, the flag a, and the flag b of the frame F4 are written to the memory (step S780), and this sub-routine ends.

Meanwhile, because for the frame F7, the consecutive blocks are in contact with the end part, this (two locations) is removed, but even when this is removed, the consecutive blocks (two locations) exist within the frame F7. Thus, the flag b=1 indicating that substantially movement blocks exist is set, and the process moves to the next step. Also, for the frames F3, F5, and F9, the consecutive blocks are not in contact with the frame image end part, and the step S740 is satisfied. In this case as well, the flag b=1 is set, and the process moves to the next step.

With the example shown in FIG. 9, the substantial movement block count mt of the frames F3, F5, F7, and F9 are respectively 20, 30, 7, and 30. FIG. 10 shows the four frames that are narrowed down from the nine frames via this process. The blocks with cross hatching of the frames shown in the drawing indicate substantially moving blocks.

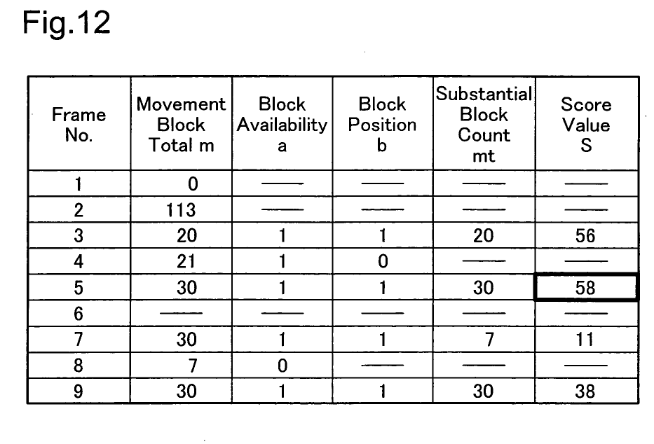

The flag 1 is raised for these substantial movement blocks, and the results of calculating the score values S of the frames F3, F5, F7, and F9 using the score coefficient table 1 shown in FIG. 11 are the table shown in FIG. 12. As shown in the drawing, the results using this score coefficient table 1 are the highest score value S of the frame F5. When sequence allocation is done based on this score value S, it is possible to do sequence allocation in the sequence of the frame F5, the frame F3, the frame F9, and the frame F7.

The score coefficient table 1 shown in FIG. 11 is set so that the closer to the center of the image center, the higher the coefficient value becomes. In other words, even if the total subject movement blocks are the same, the score value S will be higher the more the movement block is positioned near the center of the overall frame image. Note that with this embodiment, using the score coefficient table 1 that is prerecorded, the score value S was calculated, but it is also possible to have the user be able to select various score coefficient tables. The various score coefficient tables will be described later.

Note that with the sequence allocation of step S670 of FIG. 7, when two frame image score values S are almost the same, the higher value for which the score value S is excluded for the substantial movement block count mt is selected. For these values as well, when they are of relatively equal merit, the item with the higher substantial movement block count mt is selected. Furthermore, when of relatively equal merit, it is also possible to make a determination using the flag b, the flag a, and finally the movement block count m to select one frame image.

In this way, with the “movement” frame image detection process shown in FIG. 7, the frame F5 is selected from the scope of three seconds of playback time, and from the next three second scope as well, the frame image is selected in the same manner. By repeating the process above, the personal computer 30 selects the frame image that most closely matches the conditions for each three section interval across the overall playback time of the moving image, and via step S360 shown in FIG. 4, this is displayed as a thumbnail in the display 43, and the overall selection process ends. In other words, the “suggested” frame images are extracted every three seconds.

A5. Score Coefficient Table:

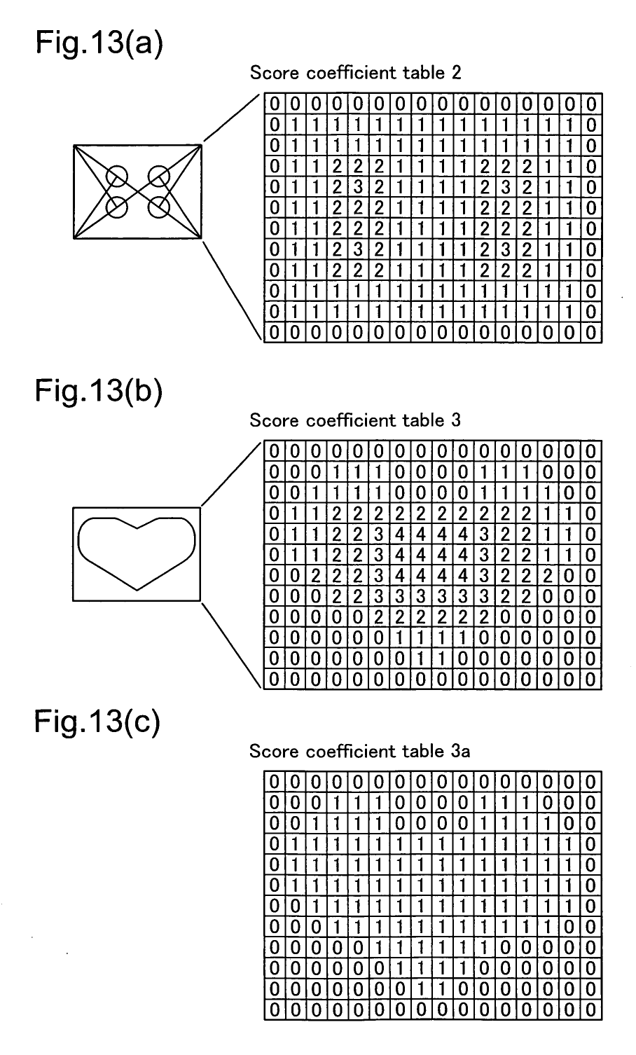

With this embodiment, when the movement frame images are extracted, the score values S are calculated using the score coefficient table 1 for which high coefficients are set (weighting) near the center for the frame image, but it is also possible to set various items to match the desired composition for the score coefficient table. FIG. 13 shows an example of the score coefficient table. The score coefficient table 2 of FIG. 13 (a) is the score coefficient table which is weighted based on the golden section ratio which is said to be good as the composition for photographs. For example, for the image selection process of this embodiment, it is possible for the user to select either the score coefficient table 1 or the score coefficient table 2. In this case, it is also possible to use a constitution such that when the user selects the “movement frame” on the operating screen shown in FIG. 2, the personal computer 30 opens the “Select Composition” menu window, processing is performed using the score coefficient table specified by the user.

The score coefficient table 3 of FIG. 13 (b) is the score coefficient table weighted near the center of the interior of a heart shape, and the score coefficient table 3a of FIG. 13 (c) is the score coefficient table weighted inside and outside the heart shape. When using the score coefficient table 3, the frames for which the movement blocks are inside the heart shape and those near the center of the heart shape have the high sequence priority. Meanwhile, when using the score coefficient table 3a, frames that have a large number of movement blocks that are within the hear shape have the high sequence priority. For example, when selecting items that have a high ratio of movement blocks being in the intended scope (anywhere is K as long as it is within the scope), by using the score coefficient table 3a, it is possible to simplify the calculation process.

With the image selection process of the first embodiment described above, attention is paid to the movement block as the characteristic volume of the frame image, and if the subject matter is “background,” the sequence priority is allocated to the frame images by the size of the movement blocks, and if the subject matter is “movement,” the sequence priority is allocated to the frame image by calculating the score value from the size and position of the movement block, or the like. Particularly when the subject matter is “movement,” the frame images are evaluated using the score coefficient table corresponding to the specified composition. Therefore, there is no sampling of a frame image that does not have meaning such as when there is a scene change. It is also possible to automatically select the frame image that matches the specified composition, and to execute the image selection process efficiently.

### B. Second Embodiment

B1. Image Search Process Matching the Composition:

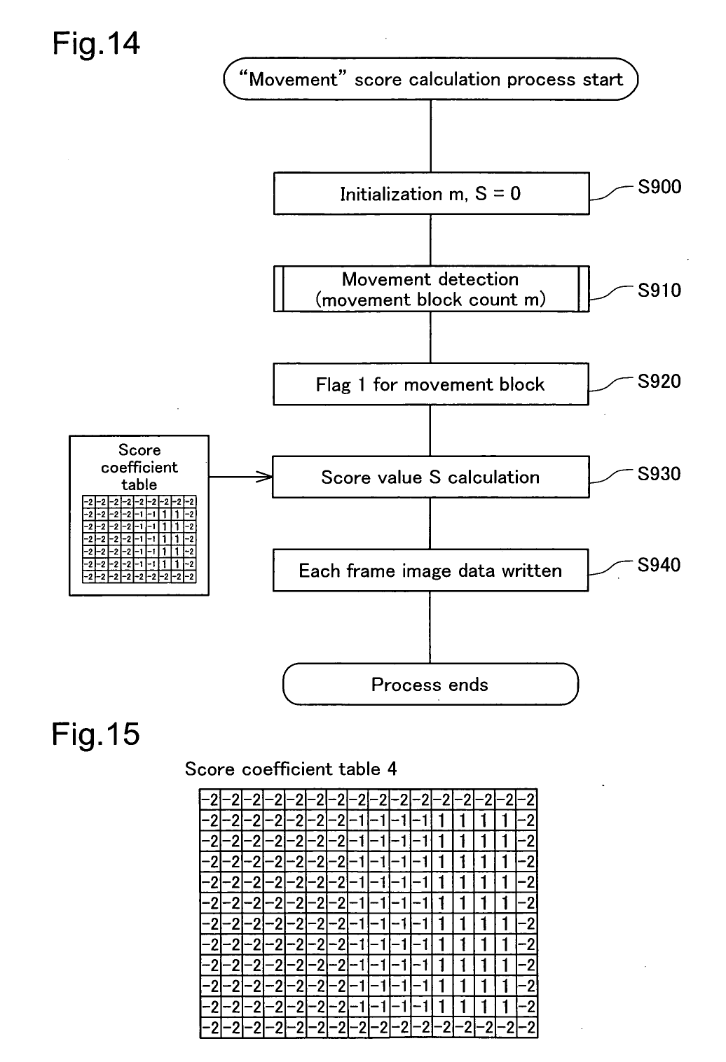

The present invention may also be applied in cases for searching for frame images that match the specified composition from within the moving image. FIG. 14 is a flow chart of the “movement” score calculation process of the second embodiment of the present invention. The image selection process of the second embodiment is only different in terms of the score calculation process of the first embodiment (step S650 in FIG. 7). Therefore, other processes and the image selection process system constitution have the same code numbers as those of the first embodiment, so a description is omitted.

The same as with the first embodiment, for the “movement” frame image detection process shown in FIG. 7, when the frame image satisfies the condition of the brightness value B, the process moves to the “movement” score calculation process shown in FIG. 14 as the process of step 650 shown in FIG. 7. The personal computer 30 initializes the coefficient used for the following score calculation (step S900), and executes the “movement detection” process for detecting the movement blocks within the candidate frame images (step S910). Note that with the second embodiment, the same as with the first embodiment, described is a case for which the “automatic” mode for every three second interval is selected, and nine candidate frame images are selected.

The personal computer 30 performs a process for raising the flag 1 for the blocks that are movement blocks within the candidate frame images, and raising the flag 0 for other blocks (step S920). Next, the coefficient values of the score coefficient table corresponding to each block are multiplied by the flag value (0 or 1) of each block. The sum of the multiplied values is obtained for all the blocks, and this is used as the score value (step S930). After the score value S is calculated, the movement block count m and the score value S are written to the memory (step S780), this sub-routine ends, and the process returns to the “movement” frame image detection process of FIG. 7.

The score coefficient table 4 of FIG. 15 is an example of the score coefficient table used for step S930. As shown in the drawing, the blocks of the part at the right side of the frame image are removed, and all negative coefficients are allocated. When this score coefficient table 4 is used, there are movement blocks in part of the area at the right side, and the score value S of the frame images that have almost no movement blocks at the left side is a positive value. Meanwhile, even if there are movement blocks in part of the area at the right side, the score value S of the frame images such as those having a large number of movement blocks at the left side is a negative value.

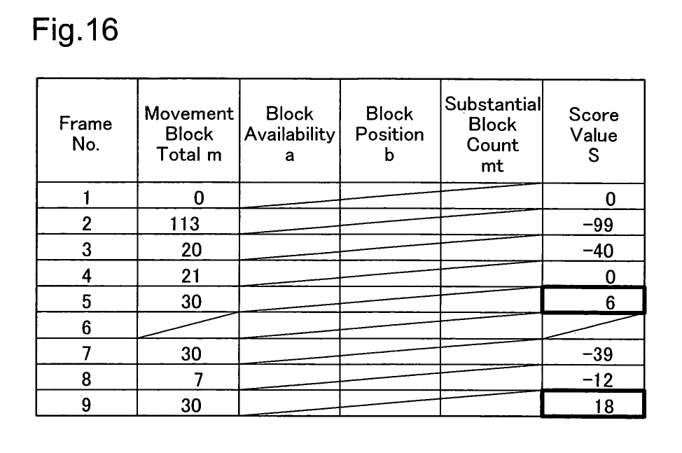

When the process of this embodiment that uses this score coefficient table 4 is applied to the candidate frame images shown in FIG. 9, the score values S shown in FIG. 16 are obtained. As shown in the drawing, the frames F5 and F9 for which the score values S are positive values are items which satisfy the desired conditions (right side). It is also possible to do sequence allocation based on these score values S of each frame, but with the second embodiment, all the frame images for which the score value S is positive (plus) are selected at step S670 of the “movement” frame image detection process of FIG. 7. In other words, by selecting the frame images for which the score value is S using the score coefficient table 4, it is possible to search for the frame images for which the movement blocks are gathered at the right side from within the moving image. Trying this kind of search, when it was not possible to find the frame images for which the score value S is positive, it is also possible to have a message that says, “There are no images that match the conditions in this scope,” displayed on the display 43.

According to the image selection process of the second embodiment described above, by setting a desired composition and using the score coefficient table corresponding to that composition, it is possible to select the frame images that match the set composition from among the plurality of frame images that constitute the moving image. In other words, the system of the second embodiment can be used as a search tool for searching for the “movement” frame images held in the specified composition from within the moving image. For example, with the moving image of a walking race captured using a digital video camera as a raw material, when a child that is the photographic subject running off from the left to the right of the image frame is the target composition, it is possible to easily search for the target scene by using the score coefficient table 4.

Note that with this embodiment, a case of extracting and processing nine candidate frame images from three second intervals was described, but it is also possible to calculate the score value S of the frame images across the entire playback time, and to detect the frame images for which the values are positive. For the heart shape composition shown in FIG. 13, it is also possible to allocate negative values to the part outside the heart, and to search for the frame images for which the score value S is positive.

It is also possible to determine the flesh colored areas within each movement block among the searched frame images to do the score calculation. In this case, for the hue system HSV (hue (H), saturation (S), brightness (V)), with the scope for which the hue H is in a scope of color circle 6° to 42° as the flesh color area determination standard, the flag 1 is allocated to the movement blocks that are in the flesh colored area, and the flag 0 is allocated to the other movement blocks (in other words, items that do not have a flesh colored area). The score coefficient corresponding to the value of each block set in this way is multiplied, and with the sum of all the blocks as the score value S, a search is done for the frame images for which the score value S is positive. In other words, a “human face” is assumed as the subject matter, and the determination of whether or not the “human face” is within the specified composition scope (e.g. the right side) is made based on whether the score value S is positive or negative. For example, when composing a heart shaped decorative frame image to contain a “human face,” it is possible to search for the frame image of the “human face” contained in the heart shape from within the images automatically.

### C. VARIATION EXAMPLES

Above, aspects of implementing the present invention were described, but the present invention is not limited in any way by these embodiments, and it is clear that various aspects may be implemented within a scope that does not stray from the key points of the present invention, and the following variations are possible, for example.

With the first embodiment, the frame images that are a specified number of candidates are extracted from a playback time interval specified by the user, and one frame image is selected that most closely satisfies the conditions. Before the selection of the one frame image with the image selection process of this first embodiment, it is also possible to do a close inspection within the scope of the count before and after with the time series of that frame image. For example, in the case of a movement frame image, the frame image with a high score value S is set from the candidate frame images, the two or three frame images around that one frame image are sampled, and the score value S is also obtained for those sampled frame images. When the score value S of the frame image that was later sampled is higher than the score value S of the one frame image set in advance, the frame image for which the score value S is high is displayed on the display 43. By performing this kind of close inspection, it is possible to select the frame image that is further suitable to the conditions.

With this embodiment, one composition (the score coefficient table) was used for the calculation of the score value S of the movement frame image, but it is also possible to prepare a plurality of compositions (score coefficient tables), to select one or a plurality of these, and to select the frame images that match each composition. It is also possible to not select a composition (score coefficient table), but rather to have the user input a score for each block and to create the score coefficient table. In addition, when the subject moving image is a moving image such as an MPEG4 or MPEG7 or the like, it is also possible to use information such as the area of interest or the object area prepared for the moving image in this way, and to perform weighting for the extraction of the images described above.

With this embodiment, the frame images that match the conditions are extracted from within the scope with segmentation of time intervals specified by the user without consideration for the switching of the scenes of the moving image, but, for example, it is also possible to acquire the moving image brightness change information, the moving image capture status, the zoom, etc. camera movement information or the like, to determine the switching of scenes within the moving image, and to extract a plurality of frame images that are candidates for each scene, By doing this, it is possible to select the frame images that match the specified setting conditions for each scene. Particularly, it is possible to easily generate thumbnail images or index images for displaying the contents of the moving image. Also, with this embodiment, moving images acquired using a digital video camera were described as the subject, but it is also possible to use as the subject a plurality of image data aligned in time series order of a level for which it is possible to determine the relative positional relationship or a moving image consisting of pseudo still image data.

With this embodiment, a personal computer was described as the image processing device of the present invention, but it is also possible to comprise the image processing functions of various devices such as a printer or digital video camera or the like and use this as the image processing device of the present invention.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. An image selection processing device for selecting as a still image part of a moving image formed as a group of images consisting of a plurality of images, the image selection processing device comprising:
an image extraction unit that extracts a plurality of images from the image groups that forms the moving image,
a movement detection unit that detects parts with movement within the image for each of the extracted images,
a sequence setting unit that evaluates the parts with movement within the detected images and allocating a sequence for each of the extracted images, and
an output unit that output the still images based on the sequence allocation.

2. The image selection processing device recited in claim 1, wherein
the sequence setting unit further includes an evaluation standard setting unit that set an evaluation standard that is a condition for evaluation the parts with movement within the detected images, and performs evaluation of the parts with movement based on the set evaluation standard.

3. The image selection processing device recited in claim 1, wherein
the image extraction unit acquires information relating to a switching of scenes for the moving image, and extracts a plurality of images for each scene,
and the image selection processing device performs the sequence allocation for each scene for the moving image, and performs outputting of the still images.

4. The image selection processing device recited in claim 1 or 2, wherein
the movement detection unit includes:
a subject image selection unit that selects a subject image having a specified correlation with each of the extracted images, and
a displacement volume detection unit for detecting the displacement volume of the position of the captured subjects between the images for the extracted images and the selected subject images,
and the image selection processing device performs displacement volume correction between the images, and based on the partial positional displacement between the images after the correction, detects the parts with movement within the extracted images.

5. The image selection processing device recited in claim 1, wherein
the output unit comprises
a related image evaluation unit for performing evaluation based on the evaluation standard for the related images that are near in terms of time sequence the still images that are candidates for the outputting, ahead of outputting the still images based on the sequence allocation,
and the image selection processing device, when the evaluated related image has a higher sequence priority than the still image of the output candidate, switches the still image of the output candidates, or outputs the related image together with the still image of the output candidates.

6. The image selection processing device recited in claim 1, wherein
the movement detection unit divides the extracted images into block units of a specified size, and is means for detecting the presence or absence of movement with the block units.

7. The image selection processing device recited in claim 6, wherein
the sequence setting unit comprises
a coefficient storage unit in which a plurality of evaluation coefficients given evaluation weighting for each of the divided blocks are stored as matrices corresponding to each block,
the image selection processing device comprising:
a matrix selection unit for selecting one matrix from the plurality of matrices as the evaluation coefficient matrix based on the evaluation standard,
a calculation unit for reading the evaluation coefficients corresponding to the detected blocks with movement from the one evaluation coefficient matrix, and calculating the overall image evaluation value using the read evaluation coefficients, and
a sequence allocation unit for doing sequence allocation based on the calculated evaluation values.

8. The image selection processing device recited in claim 7,
the image selection processing device comprising means for doing sequence allocation based on the status of the blocks with movement within each of the images when a plurality of images are extracted for which the difference of the evaluation values is within a specified scope.

9. The image selection processing device recited in claim 6, wherein
the sequence setting unit comprises:
a flesh colored area extraction unit for extracting flesh colored areas indicating a flesh colored hue for the movement blocks that are blocks determined to have movement within the detected images,
and the image selection processing device performs the sequence allocation of the extracted images such that the images with a higher movement block count comprising the extracted flesh colored areas have a higher sequence priority.

10. The image selection processing device recited in claim 7, wherein
the plurality of evaluation coefficient matrices have coefficients corresponding to the weighting set for each block based on a predetermined specified composition.

11. The image selection processing device recited in claim 7, wherein
the sequence setting unit performs the sequence allocation of the extracted images using the evaluation value for which the value of the number of blocks with movement is excluded.

12. The image selection processing device recited in claim 1, wherein
when the evaluation standard are the standard for selecting the parts with little movement within the images, the sequence setting unit sets the higher level in sequence from the images for which the total area of the parts with movement detected for each of the extracted images is small.

13. An image selection processing device for selecting as still images part of a moving image formed as a group of images consisting of a plurality of images, comprising:
an image extraction device for extracting a plurality of images from the group of images that form the moving image,
a sensor for detecting the parts with movement within the images for each of the extracted images,
an aligner for evaluating the parts with movement within the detected images, doing sequence allocation for each of the extracted images, and aligning the images, and
an output device for outputting the still images based on the sequence allocation.

14. An image selection method for selecting as still images part of a moving image formed as a group of images consisting of a plurality of image,
the image selection method
extracting a plurality of images from the group of images that form the moving image
detecting the parts with movement within the images for each of the extracted images,
evaluating the parts with movement within the detected images and performing sequence allocation for each of the extracted images, and
outputting the still images based on the sequence allocation.

15. A computer program product for realizing by a computer the process of selecting as a still image the parts of a moving image formed as a group of images consisting of a plurality of images,
comprising a program code for being read and executed in a computer and a medium for storing the program code,
the program code comprising:
a first program code for extracting a plurality of images from the group of images that form the moving image,
a second program code for detecting the parts with movement within the images for each of the extracted images,
a third program code for evaluating the parts with movement within the detected images, and doing sequence allocation for each of the extracted image, and
a fourth program code for outputting the still images based on the sequence allocation.

16. A recording medium on which is recorded the computer program recited in claim 15 to be readable by a computer.
